(19) United States
(12) Patent Application Publication
(10) Pub. No.: US 2015/0284143 A1
(43) Pub. Date: Oct. 8, 2015

(54) PACKAGING FOR A SPRAYABLE COSMETIC FLUID CONSTITUTED BY A FLEXIBLE POUCH AND A PERIPHERAL FRAME

(71) Applicant: PERFRANCE, Cormeilles en Vexin (FR)

(72) Inventor: Nicolas Herisson, Puteaux (FR)

(21) Appl. No.: 14/441,185

(22) PCT Filed: Dec. 9, 2013
(86) PCT No.: PCT/FR2013/052994

§ 371 Date: May 7, 2015

(30) Foreign Application Priority Data
Dec. 12, 2012 (FR) 1261914

(51) Int. Cl. B65D 33/02; B05C 17/005; B65D 25/38; A45D 34/04; B65D 6/00

(52) U.S. Cl. CPC B65D 33/02; A45D 34/04; B65D 11/20; B65D 25/38; B05C 17/00569

(57) ABSTRACT

A packaging for a cosmetic fluid sprayable by an air-intake pump comprised of a flexible pouch having on one of the peripheral bands thereof, an insert for fastening the pump, the insert opening into the pouch, and by a peripheral frame, the insert cooperating with the frame in the usage position of the packaging. The pouch is connected to the frame along the entirety of its peripheral bands in order to ensure that the pouch is immobile along the entire height of same, the width of the frame being greater than or equal to the width of the peripheral band of the pouch extending from the lateral seam between the peripheral seam of the pouch and the lateral side of the pouch, the frame being open on at least 80% of the front surfaces of the pouch, the lower part of the frame forming a base, the frame consisting of two identical shells between which the pouch is secured.

### BACKGROUND

1. Field of the Invention

The present invention relates to the packaging of sprayable cosmetic fluids and more particularly perfumes. Typically, perfumes are packaged in glass bottles provided with air-intake pumps ensuring a constant overall volume in the bottle.

Packaging perfumes in flexible pouches, provided with pumps, the manufacturing cost of which is low, but the appearance or use of which are generally far from satisfactory, is also possible.

The invention comes within the scope of a packaging line using a flexible pouch provided with a pump, but associating a stiffening element ensuring comfortable use similar to a conventional perfume packaging for example, while limiting the amount of material.

2. State of the Art

Fluid or perfume dispensers associating a flexible pouch provided with a pump with a rigid shell are known from the prior art. The utility model DE 202008002856 discloses a perfume bottle consisting of a pouch provided with a pump, filled with perfume and surrounded by a box, so that the pouch is interchangeable.

Dispensers constituted of a rigid shell in two parts, but the connecting line of which extends horizontally when the dispenser is held upright are also known from the prior art. Such a device is described for example in the document FR-2 081 244.

An alternative solution described in the patent FR 9905888 is known from the state of the art. This patent describes a fluid product dispenser comprising:

a flexible pouch containing a fluid product and provided with an opening,

a dispensing member such as a pump,

a shell surrounding said flexible pouch and provided with an opening which coincides with that of the flexible pouch. This shell is formed in two parts connected together along a connection line passing through the opening of said shell so that each shell part forms a part of the opening of the shell.

Dispensers associating a flexible pouch provided with a pump and associated with gripping means such as holes for the passage of the fingers or holding means such as a solid rigid shell are known from the prior art.

The patent FR0000782 provides a teaching on means for gripping a flexible pouch provided with a pump, with said gripping means enabling the passage of the fingers and being located on either side of the pump in order to actuate the pusher thereof.

The solutions of the prior art are not entirely satisfactory for the distribution of quality fragrances.

Firstly, packaging comprising no stiffening elements and providing gripping means such as locations for the passage of the index and the middle finger requires the user to actuate the pump with his/her thumb. This results in an inelegant and unusual gesture for a bottle of perfume. This solution is in particular described in patent FR0000782, which provides for two extensions on either side of the pump. In addition, the exposed welds on the pouch are unpleasant when gripping and are liable to be the source of cuts for the user.

Secondly, some solutions of the prior art provide an inner frame for the flexible pouch as described in the patent FR0000782. This implies a direct contact between the frame and the product, which results in problems of degradation of delicate contents sensitive to oxidation or chemical reactions with the materials constituting the frame.

Thirdly, some of the solutions, notably those described in the patent FR9905888, provide flexibility of the pouch with respect to the frame, which leads to deformation and disgraceful folds, and the generation of holes between the frame and the edge of the pouch under certain circumstances, notably when and as the content is distributed.

Fourthly, the solutions of the prior art require the design and use of at least two moulds, for producing symmetrical parts.

### SUMMARY

To overcome the disadvantages of the prior art, the present invention relates to packaging for a cosmetic fluid sprayable by an air-intake pump, constituted by a flexible pouch having, on one of the peripheral bands thereof an insert for fastening said pump, with said insert opening into the pouch, and by a peripheral frame, with said insert cooperating with said frame in the usage position of the packaging, characterized in that said pouch is connected to the frame along the entirety of its peripheral bands in order to ensure that said pouch is immobile along the entire height of same, with the width of the frame being at least equal to the width of the peripheral band of the pouch extending at the lateral weld between the peripheral seam of the pouch and the side edge of said pouch, said frame being open on at least 80% of the front surfaces of the pouch, the lower part of said frame forming a base, said frame consisting of two identical shells between which said pouch is secured.

It should be understood that the flexible pouch is of the U-shape or expandable type.

Advantageously, the shells comprise side members, with said members having an inner edge and an outer edge, with said outer edges being positioned side by side when two shells are assembled to form a frame, with said inner edges defining a space for holding the flexible pouch without puncturing or deforming same when two shells are assembled to form a frame.

It should be understood that the flexible pouch is closely held between the two shells of a frame according to the invention, with the inner edges of the two mounted shells fitting the shape of said flexible pouch. The space between the two inner edges of the frame enables the frame to hold the pouch without deforming or pinching or puncturing same.

Advantageously, said shells forming the frame are coupled by fastening means 20, 21 extending over the entire height of the pouch 1 such as glue and/or a plurality of complementary coupling means.

It should be understood that the shells may be hollow or solid.

The hollow shells comprise a plurality of complementary coupling means, such as spikes, pins or clips. The coupling means are preferably located along the outer edge of the shells and invisible when the frame is mounted. Even more preferably, such coupling means comprise clips distributed over the entire height of the shell and at least one pin for centering the two shells around the pouch upon assembly. Preferably, the pins are located on at least one inner corner of the shells. According to one embodiment, the complementary coupling means are non-removable clips.

According to another embodiment, the shells are assembled by ultrasonic or heat welding to form the frame around the flexible pouch. In this embodiment, the outer edge of the frame extends into a 2 to 3 mm wide solid area to enable welding, with such area flaring toward the inner edge of the frame to create a space adapted to receive the flexible pouch without deforming or puncturing same.

According to an alternative embodiment, each one of the shells has a convex lower area to form the base after connection.

According to a particular embodiment, the frame has, at its lower part, a width greater than the lateral longitudinal members.

At its lower part, each one of the shells preferably has a transverse partition to form a bottom when said shells are assembled to form the frame.

Advantageously, the lower part of the shells comprises a peripheral curl so that the frame formed by two assembled shells rests on the support through said peripheral curl.

It should be understood that the transverse partition intended to form a bottom does not entirely rest on the support whereon the frame is positioned, since the curl only is in contact with the support.

In an alternative solution, each one of the shells has, at its lower part, an open area so that the bottom of the pouch is visible when said shells are assembled to form the frame.

It should be understood that in this alternative embodiment, the curl is in contact with the support and that the flexible pouch is visible when the frame is turned upside down. The open area may extend up to the peripheral curl.

According to a preferred embodiment, the side edges of the frame have a radius of curvature ranging from 2 to 5 millimetres.

According to a first exemplary implementation, said shells constituting the frame are made by plastic injection moulding.

The material used may be mass-dyed and have iridescent, matt, shiny, soft, rough . . . effects.

According to a second exemplary implementation, said shells constituting the frame are made by stamping a metal sheet.

According to a third exemplary implementation, said shells constituting the frame are produced by thermoforming a plant material.

### BRIEF DESCRIPTION OF THE DRAWINGS

The present invention will be better understood upon reading the following description, while referring to the appended drawings corresponding to two non restrictive embodiments wherein:

FIG. 1 shows an exploded view of a packaging according to the invention;

FIG. 2 shows a front view of said packaging;

FIG. 3 shows a side view of said packaging;

FIG. 4 shows a view of the inside of a shell according to a second exemplary embodiment;

FIG. 5 shows a top view of said shell according to a second exemplary embodiment; and

FIG. 6 shows a frame mounted according to a second exemplary embodiment according to the invention.

### DETAILED DESCRIPTION

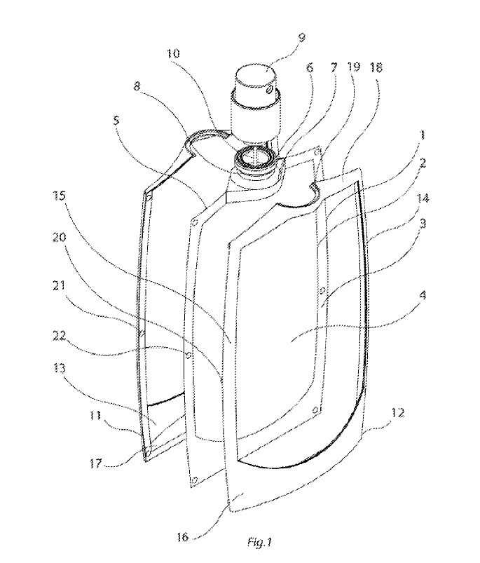

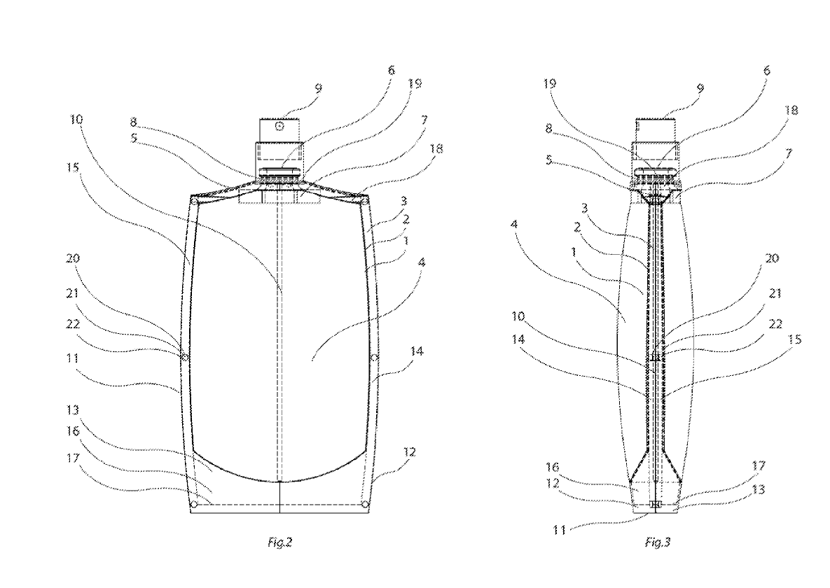

FIG. 1 shows an exploded view of an exemplary embodiment of a packaging according to the invention.

Perfume bottles generally have a volume of 30 ml or 50 ml or 100 ml. The present invention is applicable to a minimum format of 50 ml and 100 ml.

The packaging according to this exemplary embodiment of the invention is constituted by a pouch 1 formed by two films made of a complex polymer-based material and aluminum foils. Such complex films with a nominal thickness of 0.01 mm for example, are cut and welded by a peripheral seam 2, in a known manner. The pouch has a heat-sealed peripheral band 3 having a width of about 2 mm, and a central volume 4 intended to receive the content.

The upper end 5 of the pouch 1 has an area wherein an insert 6 made of plastic material is welded.

Such insert 6 has a body 7 gone through by a central conduit. This body 7 is heat-sealed with both faces of the pouch 1 to provide a mechanical connection between the insert 6 and the pouch 1 and provide sealing.

Such body 7 has an annular groove 8 enabling the mechanical connection with the frame 11 described hereunder.

The insert 6 is intended to receive an air-intake pump 9, making it possible to expel and spray a volume of the contents of the flexible pouch 1, by an axial pressure exerted on the pump 9, and to cause air to be taken in when releasing the pressure. The pump 9 is extended by a plunger tube 10 extending into the central volume 4 of the pouch 1.

The overall volume of the pouch 1 remains constant, with the volume of fluid sprayed being replaced by a volume of air entering the pouch 1 through the air-intake system.

The frame 11 is constituted of two strictly similar (and not only symmetrical) shells 12, 13 and defining a window, partially showing the flexible pouch 1.

Each shell 12, 13 has two side members 14, 15 the width of which is greater than or equal to the width of the peripheral band 3, so as to cover the weld seam 2.

The side members 14, 15 avoid the unpleasant feeling of shearing and avoid the risk of cutting when grasping a flexible pouch by the ends thereof.

The fastening of the pump 9 on the frame 11 makes it possible to actuate the pump with the index, which is usual for using a perfume in a glass bottle but unusual for using a perfume in a flexible pouch.

The width of such side members 14, 15 may vary to give a fancy external shape, or optionally to form finger positioning areas.

The side members 14, 15 have a thickness of a few millimetres, preferably 2 to 20 millimetres, with a radius of curvature of approximately 3 millimetres.

The side members 14, 15 are extended, at the lower parts thereof, by a convex area 16 having a greater width. This convex area 16 forms the base providing a stable resting of the packaging.

At this base, the shell 12, 13 may have a transverse partition 17 to form a bottom. It may also have no such transverse partition to form an open bottom.

The upper part of the shells 12, 13 is closed by a transverse portion 18 connecting the two members 14, 15. Such transverse portion 18 is perpendicular to the axis of the insert 6, and has a cut-out 19 the shape of which matches the annular groove 8 of said insert 6.

Each one of the shells 12, 13 has its side members 14, 15 provided with spikes 20 and matching cavities 21, so configured as to enable assembling of two shells 12, 13 of the frame 11 by snapping, with the spikes 20 going through holes 22 formed in the peripheral band 3 of the pouch 1.

Such spikes 20 and cavities 21 can be alternated. According to one alternative solution, one of the side members 14, 15 of the shell 12, 13 is provided with cavities 21 and the other side member 14, 15 of the shell 12, is provided with spikes 20, so as to enable the implementation of two identical shells 12, 13 to form the frame 11.

The side members 14, 15 have at least three fastening and assembling means, so as to maintain the pouch 1 over the entire length of the side member 14, 15, without any possible deformation of the edge of the pouch 1 with respect to the reference position thereof.

The frame 11 may be made by injection moulding or by stamping a metal material, or still by thermoforming a plant material.

According to an alternative embodiment, the frame 11 may also have a neck for hiding the base of the pump, which avoids using a pump cover.

Several longitudinal branches, or patterns positioned in the window defined by the side members 14, 15, the base and the upper frame part may also be provided.

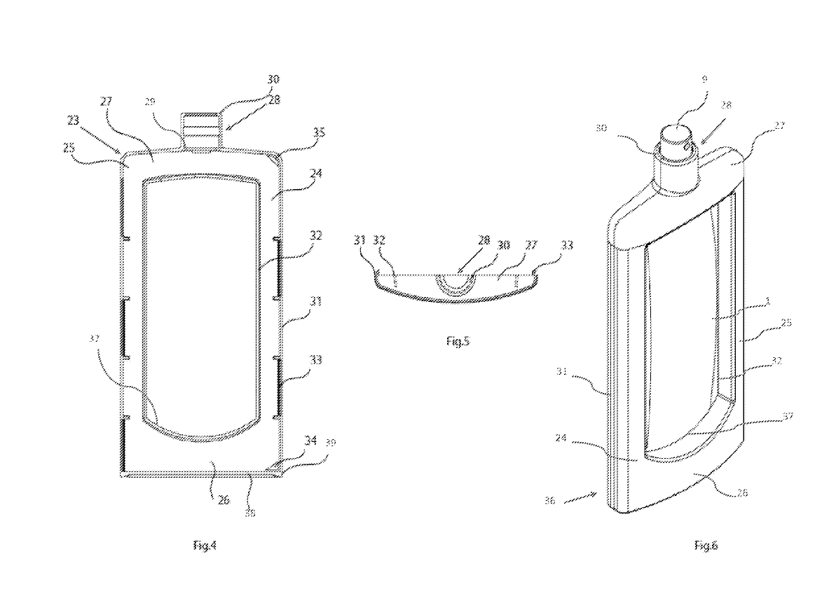

FIGS. 4, 5 and 6 show a second exemplary embodiment according to the invention.

FIG. 4 shows a shell 23 for realizing a frame consisting of two identical shells 23 surrounding a flexible pouch filled with a cosmetic fluid.

Such shells 23 are constituted by two lateral parallel members 24, 25 connected with a concave lower transverse part 26 and a transverse upper part 27. Such upper part 27 comprises a semi-cylindrical hollow extension 28 having a shape matching the insert of the pump of the pouch. Such extension 28 comprises means for holding the insert of the pump consisting of two radial lugs 29, 30, one 29 at the base of the extension 28 and the other one 30 at the upper end of the extension 28 extending over the entire circumference of the extension 28 so that, when two shells 23 are assembled together to form a frame, they constitute a lower retaining ring and an upper retaining ring in order to immobilize the insert of the pump in the frame. When activated by the user, the pump 9 does not move and does not sink. The shape of the shells at the upper part 27 is matching and adjusted to the size of the insert for fixing the pump on the flexible pouch.

The lateral members 24, 25 comprise an outer edge 31 and an inner edge 32, with said inner edge 32 defining the central aperture in the frame through which the pouch is visible. The frame is open on at least 80% of the front surfaces of the pouch and may have ornaments or fancy shapes. The pouch may also be ornamented, decorated, printed. Several longitudinal branches, or patterns positioned in the window defined by the side members 24, 25, the base and the upper part of the frame may also be provided.

When the two shells 23 are assembled to form a frame, the inner edges 32 are not joined, so that the inner edges 32 of two mounted shells define a slot a few millimetres, for instance 2 mm, wide wherein the flexible pouch is held. The pouch 1 thus secured between the shells 23 does not move, is not deformed and is inflated. The slot extends in depth down to the peripheral weld seam 2 of the pouch 1. Thus the flexible pouch 1 cannot be damaged or pierced by the complementary coupling means of two shells 23. The peripheral band 3 of the pouch is stuck between the two shells 23 forming the frame. In this exemplary embodiment, the peripheral band of the pouch has no hole for the passage of the complementary coupling means. The lateral members 24, 25 at the outer edge 31 comprise at least two clips 33, 1 to 2 cm long, with such clips 33 cooperating with the outer edge of the second shell to form a frame. Such clips 33 cannot be disassembled. The outer edges 31 of the side members 24, 25 of two shells 23 mounted to form a frame are joined along the entire height of the frame. The clips 33 are not visible when the two shells 23 are assembled into the frame.

The shell also comprises at least one centering pin 34, 35. This pin 34, 35 is for example positioned in a lower corner and/or in the upper corner of the same side member 24 of the shell 23. Such pins 34, 35 are used to align the two shells 23 when they are brought together to form a frame surrounding a flexible pouch 1. Such pins 34, 35 have a triangular cross-section for example.

The side members 24, 25 are extended by a convex lower transverse part 26 having a greater width. Such lower part 26 forms the base 36. The inner edges 37 of the shells 23, at the base 36, are not jointed and define a space the dimensions of which are adjusted to those of the flexible pouch 1 so that the pouch 1 is not subjected to mechanical stresses. The base 36 enables a stable positioning of the packaging according to the invention. At this base 36, the shell 23 may have a transverse partition 38 to form a bottom. Such transverse partition 38 which forms the base comprises a peripheral curl 39 over the entire width of the lower portion of the shell 23. Such peripheral curl 39 is invisible when the packaging is placed on a support and provides stability to the packaging.

1-12. (canceled)

13. A packaging for a cosmetic fluid sprayable by an air-intake pump comprising:
a flexible pouch having on one of the peripheral bands thereof an insert for fastening said pump, with said insert opening into the pouch, and by a peripheral frame, with said insert cooperating with said frame in the usage position of the packaging,
wherein said pouch is connected to the frame along the entirety of its peripheral bands in order to ensure that said pouch is immobile along the entire height of the pouch, with the width of the frame being at least equal to the width of the peripheral band of the pouch extending from the lateral weld between the peripheral seam of the pouch and the lateral edge of said pouch, with said frame being open on at least 80% of the front surfaces of the pouch, with the lower part of said frame forming a base, with said frame consisting of two identical shells between which said pouch is secured.

14. The packaging according to claim 1, wherein the shells comprise side members, with said members having an inner edge and an outer edge, with said outer edges being positioned side by side when two shells are assembled to form a frame, with said inner edges defining a space for holding the flexible pouch without puncturing or deforming the pouch when two shells are assembled to form a frame.

15. The packaging according to claim 13, wherein said shells forming the frame are coupled by fixing means extending over the entire height of the pouch such as glue and/or a plurality of complementary coupling means.

16. The packaging according to claim 13, wherein each shell has a convex lower area for forming the base after connection of each shell.

17. The packaging according to claim 13, wherein the frame has, at the lower portion thereof, a width greater than the side members.

18. The packaging according to claim 13, wherein each shell has, at the lower portion thereof, a transverse partition for forming a bottom when said shells are assembled to form the frame.

19. The packaging according to claim 13, wherein the lower part of the shells has a peripheral curl so that the frame formed by two assembled shells rests on the support via said peripheral curl.

20. The packaging according to claim 13, wherein each shell has, at its lower part, an open area so that the bottom of the pouch is visible when said shells are assembled to form the frame.

21. The packaging according to claim 13, wherein the lateral edges of the frame have a radius of curvature ranging from 2 to 5 millimeters.

22. The packaging according to claim 13, wherein said shells constituting the frame are made by plastic injection moulding.

23. The packaging according to claim 13, wherein said shells constituting the frame are made by stamping a metal sheet.

24. The packaging according to claim 13, wherein said shells constituting the frame are produced by thermoforming a plant material.
